(19) United States
(12) Patent Application Publication
(10) Pub. No.: US 2025/0381900 A1
(43) Pub. Date: Dec. 18, 2025

(54) VIBRATION GENERATOR, TACTILE PRESENTATION DEVICE, AND SEAT SYSTEM

(71) Applicant: ALPS ALPINE CO., LTD., Tokyo (JP)

(72) Inventors: Shinichi SAGAWAI, Miyagi (JP); Kunio SATO, Miyagi (JP)

(21) Appl. No.: 19/314,388

(22) Filed: Aug. 29, 2025

Related U.S. Application Data
(63) Continuation of application No. PCT/JP2024/007165, filed on Feb. 27, 2024.

(30) Foreign Application Priority Data
Apr. 7, 2023 (JP) 2023-062800

(51) Int. Cl. B60N 2/90; B60Q 9/00; G05B 13/04

(52) U.S. Cl. CPC B60N 2/976; B60Q 9/00; G05B 13/042; B60N 2002/981

(57) ABSTRACT

A vibration generator is provided and includes: a housing; a vibrator housed in the housing and including a permanent magnet or an electromagnetic coil; an elastic support housed in the housing and elastically supporting the vibrator; a drive part housed and provided in the housing and including the electromagnetic coil capable of generating a force for magnetically attracting the vibrator including the permanent magnet in a first direction, or the permanent magnet capable of generating the force for magnetically attracting the vibrator including the electromagnetic coil in the first direction; and a weight provided in a part of the housing located toward a second direction crossing the first direction.

### CROSS-REFERENCE TO RELATED APPLICATIONS

This application is a continuation application of International Application No. PCT/JP2024/007165, filed on Feb. 27, 2024, and designated the U.S., which is based upon and claims priority to Japanese Patent Application No. 2023-062800, filed on Apr. 7, 2023, the entire contents of which are incorporated herein by reference.

### BACKGROUND

### 1. Field of the Invention

The present disclosure relates to a vibration generator, a tactile presentation device, and a seat system.

### 2. Description of the Related Art

Conventionally, there have been vibration motors including a housing, a substrate, a coil, a vibrator, a first elastic member, and a second elastic member. When the coil is energized in a state where the displacement of the vibrator is zero, the vibrator vibrates in a lateral direction (one of two orthogonal axes in a plan view (X-direction)) due to the interaction between the magnetic field generated by the coil and the magnetic field generated by a magnet of the vibrator (See, for example, Japanese Laid-Open Patent Application No. 2018-118231).

### SUMMARY

A vibration generator according to an embodiment of the present disclosure includes: a housing; a vibrator housed in the housing and including a permanent magnet or an electromagnetic coil; an elastic support housed in the housing and configured to elastically support the vibrator; a drive part housed and provided in the housing and including the electromagnetic coil capable of generating a force for magnetically attracting the vibrator including the permanent magnet in a first direction, or the permanent magnet capable of generating the force for magnetically attracting the vibrator including the electromagnetic coil in the first direction; and a weight provided in a part of the housing located toward a second direction crossing the first direction.

A tactile presentation device according to the embodiment of the present disclosure includes: a housing; a vibrator housed in the housing and including a permanent magnet or an electromagnetic coil; an elastic support housed in the housing and configured to elastically support the vibrator; a drive part housed and provided in the housing and including the electromagnetic coil capable of generating a force for magnetically attracting the vibrator including the permanent magnet in a first direction, or the permanent magnet capable of generating the force for magnetically attracting the vibrator including the electromagnetic coil in the first direction; a vibration generator including a weight provided in a part of the housing located toward the second direction crossing the first direction; and control circuitry configured to control the drive of the electromagnetic coil.

A seat system according to the embodiment of the present disclosure includes: a seat including a seat portion and a backrest portion; and a tactile presentation device, wherein
the tactile presentation device includes a vibration generator; and control circuitry, wherein
   the vibration generator includes
      a housing provided in a cushion member of the seat portion or the backrest portion of the seat;
      a vibrator housed in the housing and including a permanent magnet or an electromagnetic coil;
      an elastic support housed in the housing and configured to elastically support the vibrator;
      a drive part housed and provided in the housing and including the electromagnetic coil capable of generating a force for magnetically attracting the vibrator including the permanent magnet in a first direction, or the permanent magnet capable of generating the force for magnetically attracting the vibrator including the electromagnetic coil in the first direction; and
      a weight provided in a part of the housing located toward a second direction crossing the first direction, and
   the control circuitry is configured to control drive of the electromagnetic coil,
the housing is embedded in the cushion member and is configured to deform both upper and lower portions of the housing in a thickness direction of the cushion member upon seating on the cushion member by a seat user,
the housing is disposed in the cushion member such that the first direction is parallel to a surface of the seat portion or the backrest portion,
the vibration generator is formed such that a center of gravity of the vibration generator and the center of gravity of the vibrator are at different locations, and
the vibration generator provides vibration that vibrates in a direction orthogonal to the surface of the seat portion or the backrest portion, along the surface of the seat portion or the backrest portion, by generating the vibration including a rotational moment by vibrating the vibrator in the first direction.

### BRIEF DESCRIPTION OF THE DRAWINGS

FIG. 1 is a diagram illustrating an example of an interior structure of a vehicle;

FIG. 2 is a diagram illustrating a configurational example of a tactile presentation device according to an embodiment;

FIG. 3 is a cross-sectional diagram illustrating a configurational example of the seat illustrated in FIG. 1, taken along a line A-A;

FIG. 4A is a diagram illustrating a configurational example of an actuator according to the embodiment;

FIG. 4B is a diagram illustrating torque for rotating the actuator according to the embodiment;

FIG. 4C is a diagram illustrating a configurational example of the actuator according to a modified example of the embodiment;

FIG. 5A is a graph illustrating an example of simulation results;

FIG. 5B is a graph illustrating an example of actual measurement results;

FIG. 6 is a diagram illustrating an example of a simulation model used to obtain simulation results of sound pressure distribution;

FIG. 7A illustrates an example of simulation results;

FIG. 7B illustrates an example of simulation results;

FIG. 7C illustrates an example of simulation results;

FIG. 7D illustrates an example of simulation results;

FIG. 8A is a diagram illustrating a length L of a weight in an X-direction and a depth d from a surface of a seat of the actuator according to the embodiment;

FIG. 8B is a diagram schematically illustrating an example of a Z-directional component of vibration when the depth d is deep; and

FIG. 8C is a diagram schematically illustrating an example of the Z-directional component of vibration when the depth d is shallow.

### DETAILED DESCRIPTION OF THE DISCLOSURE

It is noted that, for example, in the case where a vibration generator is disposed in a portion having a limited thickness in order to generate vibration on a surface of the portion, a vibration generator in which the vibrator vibrates in a direction parallel to the surface of the portion may be easier to be disposed. The portion having a limited thickness may be, for example, a seat portion or a backrest portion of a seat.

However, in a vibration generator in which a vibrator vibrates in a direction parallel to the surface of the portion concerned, the vibration transmitted to the surface of the portion concerned is weak, and sufficient vibration intensity cannot be obtained. Such an issue becomes further pronounced when the portion concerned is a flexible portion. The flexible portion is, for example, a urethane sheet or a sponge provided inside the seat or the backrest portion of the seat.

The present disclosure provides a vibration generator, a tactile presentation device, and a seat system in which a vibrator vibrates in a direction along a surface on which vibration is to be generated and the vibration can be generated in a direction perpendicular to the surface on which vibration is to be generated.

An embodiment to which the vibration generator, tactile presentation device, and seat system of the present disclosure are applied will be described in the following.

### Embodiment

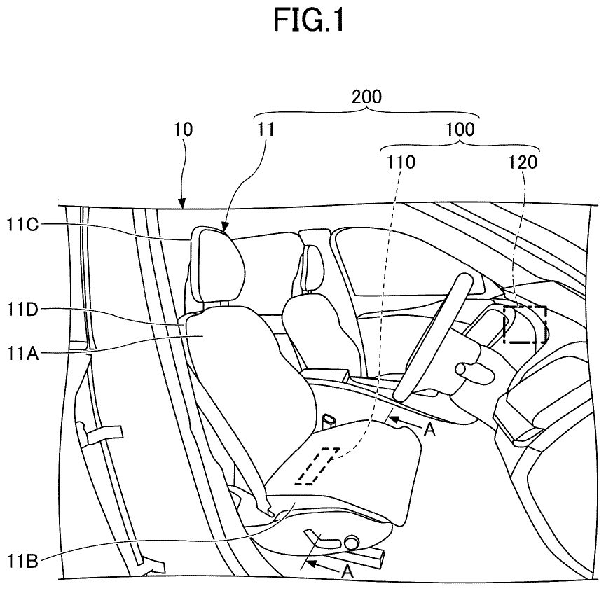

FIG. 1 is a diagram illustrating an example of the configuration in the interior of a vehicle 10. A seat 11 is disposed in the interior of the vehicle 10. The seat 11 includes a backrest portion (seat back) 11A, a seat portion (seat cushion) 11B, a headrest 11C, and a seat fabric 11D. The backrest portion 11A, the seat portion 11B, and the headrest 11C are covered with the seat fabric 11D.

In the present embodiment, an example of a target (Hereinafter, the term “target” is also used.) to which a tactile presentation device 100 is attached is a seat 11, and the seat 11 is the driver's seat, which will be described in the following. Therefore, in the following description, the user of the seat 11 is a driver. However, the seat 11 may be any seat provided in the vehicle 10, such as a passenger seat or a rear seat. The seat 11 may be provided in an object other than the vehicle 10. An example of the target is not limited to the seat 11, but may be used while being in contact with at least a part of the body of the user, and the vibration of the target generated by the tactile presentation device 100 may be transmitted at least to a part of the body. For example, the target may be a wearable device (for example, a wristband type, a belt type, a wearing suit type, etc.), a device for supporting a person with hearing impairment or visual impairment, or a device such as a power assist suit for work support. In the following description, an example in which the target is a seat 11 will be described, but the contents described for the seat 11 are equally applicable in the case where the target is other than the seat 11.

The vehicle 10 is equipped with a seat system 200 of the present embodiment. The seat system 200 includes the seat 11 and the tactile presentation device 100. The tactile presentation device 100 includes an actuator 110 and a controller 120. The actuator 110 is an example of the vibration generator. In FIG. 1, the actuator 110 is illustrated by a broken line.

The tactile presentation device 100 is a device for presenting tactile sensation to a user seated on the seat 11 by driving and vibrating the actuator 110 provided in the seat 11. By presenting the tactile sensation, for example, information about the vehicle 10 is reported to the user.

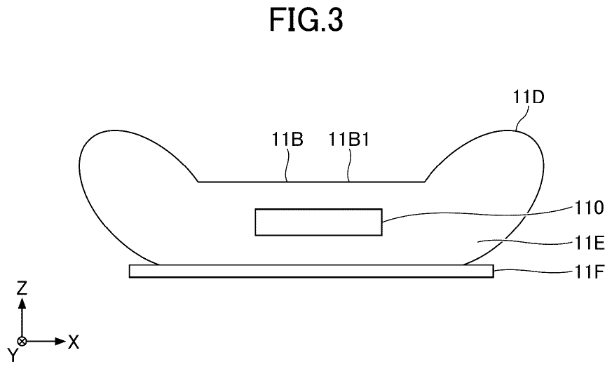

As an example, the seat portion 11B includes one actuator 110. As an example, the actuator 110 is disposed inside a cushion member provided on a back side of the seat fabric 11D of the seat portion 11B. The location where the actuator 110 is disposed, the surrounding environment, and the like will be described in the following with reference to FIG. 3.

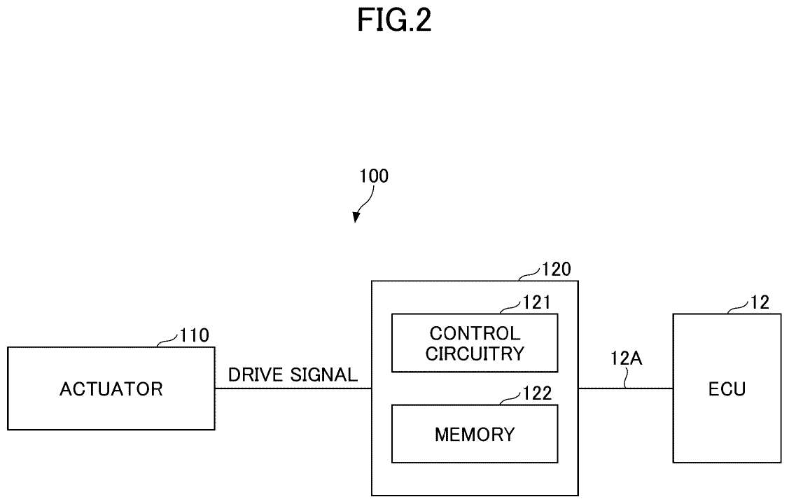

The controller 120 is disposed on the back side of the dashboard as an example. The following description will be made with reference to FIG. 2 in addition to FIG. 1.

FIG. 2 is a diagram illustrating a configurational example of the tactile presentation device 100. FIG. 2 shows an electronic control unit (ECU) 12 in addition to the tactile presentation device 100. The ECU 12 is an ECU for controlling a navigation system of the vehicle 10. Although the ECU 12 described in the following is the ECU for controlling the navigation system, the ECU 12 may be an ECU other than the ECU for controlling the navigation system. A controller 120 may be included in the ECU 12.

The actuator 110 is connected to the controller 120 via a communication cable 110A, and the controller 120 is connected to the ECU 12 via a communication cable 12A. The controller 120 controls the drive of the actuator 110.

The communication cables 110A and 12A are communication cables that conform to standards such as controller area network (CAN). The communication between the controller 120 and each of the actuator 110 and the ECU 12 is not limited to wired communication via the communication cables 110A and 12A, and a part or all of the communication may be achieved by wireless communication.

The controller 120 includes control circuitry 121 and a memory 122. The controller 120 is implemented by a computer including a central processing unit (CPU), random access memory (RAM), read only memory (ROM), an input/output interface, an internal bus, and the like. The control circuitry 121 is a functional block representing the function (functions) of the program executed by the controller 120. The memory 122 functionally represents the memory of the controller 120.

When an event is reported from the ECU 12, the control circuitry 121 reads out the vibration pattern corresponding to the type of the event from the memory 122, and outputs a drive signal of the read vibration pattern to the actuator 110. Thus, the actuator 110 is driven by the vibration pattern corresponding to the type of the generated event. The memory 122 stores programs, data, and the like used by the control circuitry 121 to drive the actuator 110. The memory 122 stores data indicating the vibration pattern corresponding to the type of the event.

<Environment in which the actuator 110 is disposed>

The following description will be made with reference to FIG. 3 in addition to FIGS. 1 and 2. FIG. 3 is a cross-sectional diagram illustrating a configurational example of the seat 11 illustrated in FIG. 1, taken along the line A-A. In FIG. 3, a frame 11F of the seat 11 is illustrated under the seat portion 11B.

An XYZ coordinate system will be defined and described in the following. An X-axis is an example of a first axis, a Y-axis is an example of a second axis, and a Z-axis is an example of a third axis. The directions parallel to the X-axis (X-direction), the Y-axis (Y-direction), and the Z-axis (Z-direction) are orthogonal to each other. In the following, the Z-direction is a vertical direction, a +Z-direction is referred to as an upward direction, and a −Z-direction is referred to as a downward direction. A planar view refers to a view as viewed on an XY-plane. The XY-plane is parallel to the horizontal plane. In the following, the length, thickness, and the like of each part may be exaggerated in order to make the structure easy to understand.

As illustrated in FIG. 3, the actuator 110 is provided inside a cushion member 11E disposed on the back side of the seat fabric 11D of the seat portion 11B. The cushion member 11E is an example of the flexible portion, and includes urethane foam or the like.

Here, as an example, the actuator 110 is disposed inside the cushion member 11E of the seat portion 11B, but the actuator 110 may be disposed inside the cushion member 11E disposed on the back side of the seat fabric 11D of the backrest portion 11A.

The actuator 110 is positioned below a surface 11B1 of the seat portion 11B, and is disposed substantially in the center of the thickness of the cushion member 11E in the Z-direction. That is, the actuator 110 is embedded in the center of the thickness of the cushion member 11E of the seat portion 11B. When the user sits on the seat portion 11B, both the upper and lower portions of the actuator 110 of the cushion member 11E are deformed, such that the user is not conscious that a hard object exists inside the cushion member 11E.

The position of the actuator 110 in the cushion member 11E in a plan view is approximately the center of the seat portion 11B in a plan view. As an example, the surface 11B1 of the seat portion 11B is approximately parallel to the horizontal plane when the user is not seated on the seat 11.

The actuator 110 is driven by a drive signal output from the controller 120 (see FIG. 2) and generates vibration. The seat 11 as the target vibrates by driving the actuator 110.

The tactile presentation device 100 vibrates the actuator 110 to transmit vibration to the user seated on the seat 11, thereby presenting tactile sensation to the user. Although the configuration in which the actuator 110 is provided in the seat portion 11B will be described in the following, the same is true if the actuator 110 is provided inside the cushion member 11E of the backrest portion 11A.

### <Vibration Direction of Vibrator in Actuator 110>

Generally, in order to generate vibration of a certain magnitude on a surface of an object, it is preferable to vibrate the vibrator perpendicularly to the surface. However, since the thickness of the cushion member 11E of the seat portion 11B of the seat 11 is limited in the Z-direction, it is difficult to vibrate the vibrator in the Z-direction inside the cushion member 11E. This is because it is difficult for the vibrator to take a sufficient vibration stroke in the Z-direction.

Under such restriction, as an example, the actuator 110 vibrates the vibrator in the X-direction. That is, by vibrating the vibrator in the X-direction, the vibrator of the actuator 110 generates vibration on the surface 11B1 of the seat portion 11B which is substantially parallel to the XY-plane.

In addition, since the actuator 110 is embedded in the cushion member 11E which has low vibration transmission efficiency, it is necessary to devise to transmit vibration of a certain intensity to the surface 11B1 of the seat portion 11B.

From this viewpoint, the actuator 110 can generate vibration including a Z-directional component while adopting a configuration in which the vibrator vibrates in the X-direction. More specifically, the actuator 110 achieves vibration including the Z-directional component by generating vibration accompanied by rotation in the entire actuator 110 like a cradle by the vibration of the vibrator in the X-direction. Details of the configuration and operation of the actuator 110 will be described in the following.

### <Details of Configuration and Operation of Actuator 110>

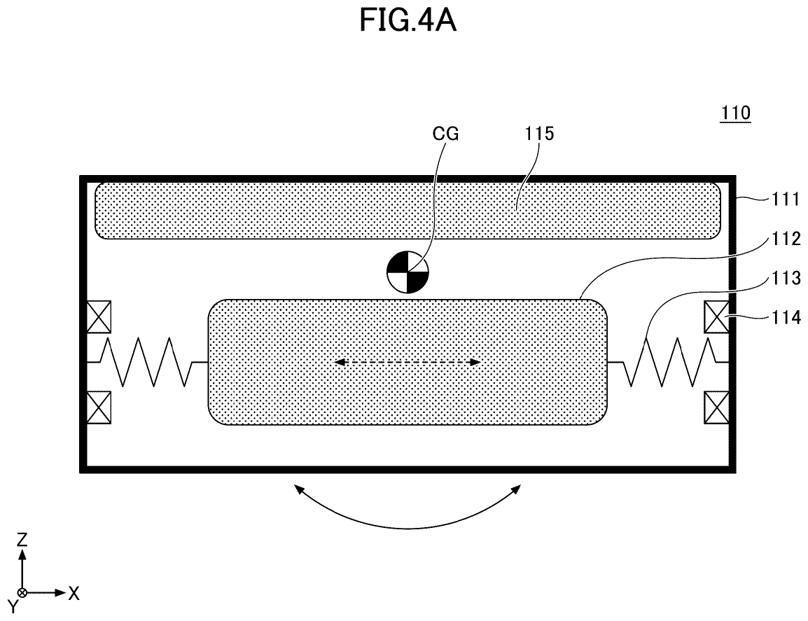

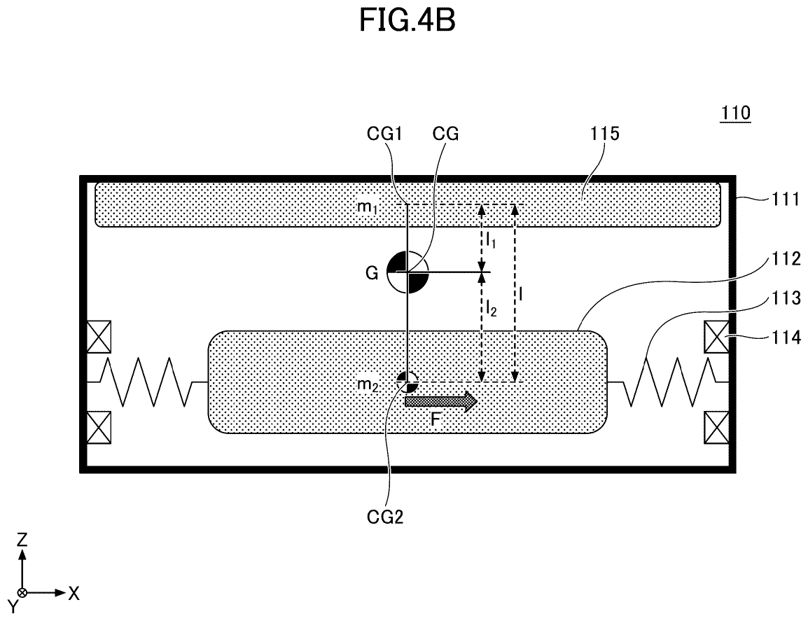

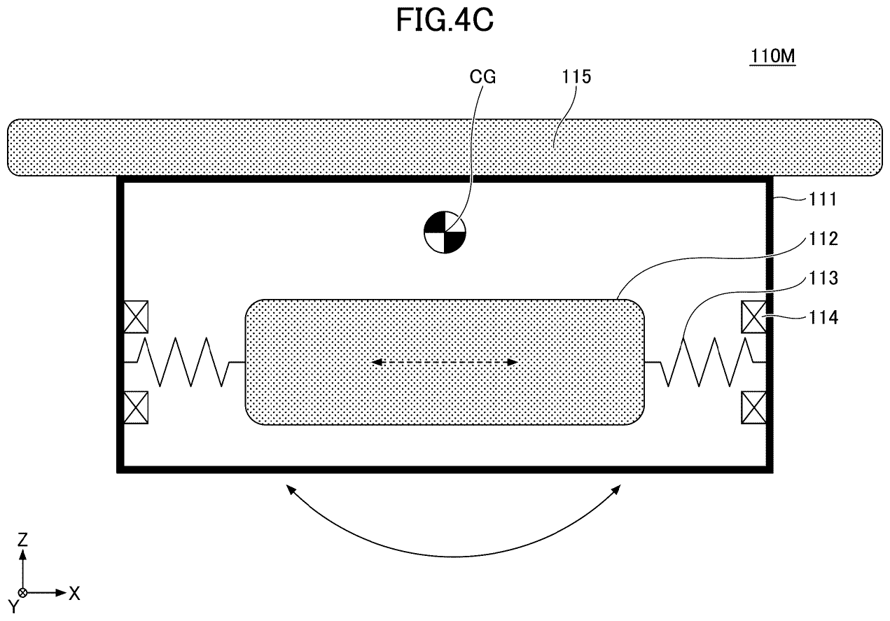

FIG. 4A is a diagram illustrating a configurational example of the actuator 110. The actuator 110 includes the housing 111, a vibrator 112, a spring 113, an electromagnetic coil 114, and a weight 115. The spring 113 is an example of the elastic support that elastically supports the vibrator 112. The electromagnetic coil 114 is an example of the drive part. In FIG. 4A, the center of gravity CG of the actuator 110 when the vibrator 112 of the vibrator 112 is stopped is illustrated.

### <Housing 111>

The housing 111 is, as an example, a box-shaped member with a hollow interior, and is a case for the actuator 110. The housing 111 is, as an example, a rectangular parallelepiped, includes six walls, and includes six outer surfaces. The housing 111 may be, as an example, made of a resin, a metal, or the like, but it is preferable to be made of a metal material from the viewpoint of securing the strength described in the following. The housing 111 is a thin plate-like case having a small thickness in the Z-direction, because the thickness of the cushion member 11E of the seat portion 11B is limited in the Z-direction. Although the housing 111 is described as a thin rectangular parallelepiped case as an example, the housing 111 may be thin only in a thickness direction (Z-direction) of the cushion member 11E, and the overall shape need not necessarily be a rectangular parallelepiped.

Moreover, the housing 111 is a part that becomes a vibration generating part when the actuator 110 vibrates, by receiving the vibration generated by the vibrator 112. The housing 111 is provided inside the cushion member 11E of the seat portion 11B, and a load is applied in the Z-direction when the user sits on the seat portion 11B. Therefore, it is sufficient that the housing 111 can function as the vibration generating part of the actuator 110 and has sufficient strength to withstand the load.

### <Vibrator 112>

The vibrator 112 is disposed inside a thin plate-like housing 111 having a small thickness in the Z-direction, and vibrates in the X-direction. In addition, it is preferable that the length of the actuator 110 in the X-direction parallel to a vibration direction of the vibrator 112 in a plan view is longer than the length in the Y-direction perpendicular to the vibration direction of the vibrator 112 in a plan view, since greater vibrations are generated.

For this reason, the vibrator 112 includes a permanent magnet having a longitudinal direction in the vibration direction (X-direction). The X-direction in which the vibrator 112 vibrates is an example of the first direction. At both ends of the vibrator 112 in the X-direction, an end portion of the spring 113, the spring 113 being provided one on each of the ±X-directional sides of the vibrator 112, is fixed. The vibrator 112 vibrates to reciprocate in the X-direction by driving the electromagnetic coils 114 provided one on each of ±X-directional sides of the vibrator 112. The actuator 110 including the vibrator 112 as described above is a linear actuator in which the vibrator 112 vibrates in the X-direction, and may be either a resonant type or a non-resonant type.

Here, as an example, the vibrator 112 in which the longitudinal direction is the vibration direction (X-direction) is explained, but the vibrator 112 need not necessarily have a shape in which the longitudinal direction is the vibration direction (X-direction). For example, the vibrator 112 may have a square shape in a plan view, and may have the longitudinal direction in the Y-direction and a transverse direction in the X-direction.

Here, as an example, the actuator 110 adopts a moving-magnet-type configuration, in which the vibrator 112 is a permanent magnet and the electromagnetic coils 114 are fixed to the housing 111. The moving magnet type actuator 110 has an advantage that greater vibration can be obtained than with the moving coil type. However, the actuator 110 may adopt a moving coil type configuration in which the vibrator 112 is an electromagnetic coil. This configuration will be described in the following together with the electromagnetic coil 114.

Here, as an example, a configuration of the actuator 110 in which the electromagnetic coils 114 are provided one on each of the ±X-directional sides of the vibrator 112 will be described. However, the actuator 110 may be configured such that the vibrator 112 vibrates in the X-direction by providing the electromagnetic coils on the lower side, the upper side, or the lateral sides when the vibrator 112 is stopped, for example.

Although a configuration in which the actuator 110 vibrates the vibrator 112 in the X-direction will be described in the following under the above-described restrictions, the actuator 110 may be configured such that the vibrator 112 vibrates in the Y-direction. In this case, the longitudinal direction of the vibrator 112 is the Y-direction.

### <Spring 113>

The spring 113 is provided one on each of the ±X-directional sides of the vibrator 112. One end of each spring 113 is fixed to the X-directional end of the vibrator 112, and the other end of the spring 113 is fixed to an inner wall of the housing 111. The spring 113 is an elastic member which is elastic and stretchable in the X-direction. The spring 113 may be capable of elastically supporting the vibrator 112 to the housing 111 in a state where the vibrator 112 can vibrate in the X-direction. The spring 113 may be, for example, a coil spring or a plate spring.
<Electromagnetic coil 114>
The electromagnetic coil 114 is wound in a YZ-planar view, and the spring 113 passes through the center of the electromagnetic coil 114. The spring 113 is fixed to the inner wall of the housing 111 while being passed through the center of the electromagnetic coil 114.

The electromagnetic coil 114 is connected to the controller 120 via a cable or the like. The electromagnetic coil 114 generates a magnetic field capable of magnetically attracting the vibrator 112 including a permanent magnet in the X-direction by current control performed by the control circuitry 121. When the control circuitry 121 periodically changes the polarity of the current flowing through the electromagnetic coil 114, a magnetic attractive force acts between the vibrator 112 including the permanent magnet and the electromagnetic coil 114, and the vibrator 112 vibrates in the X-direction.

When the actuator 110 is a moving coil type, the vibrator 112 is the electromagnetic coil, and the permanent magnet is fixed to the housing 111 instead of the electromagnetic coil 114. In this case, the permanent magnet fixed to the housing 111 instead of the electromagnetic coil 114 is an example of the drive part.

That is, when the actuator 110 is a moving magnet type, the drive part is the electromagnetic coil 114 provided on a housing 111 side, capable of magnetically attracting the vibrator 112 in the longitudinal direction, and capable of generating a magnetic attractive force with the vibrator 112 including the permanent magnet. When the actuator 110 is the moving coil type, the drive part is the permanent magnet provided on the housing 111 side, capable of magnetically attracting the vibrator 112 in the longitudinal direction, and capable of generating a magnetic attractive force with the vibrator 112 including the electromagnetic coil.

### <Weight 115>

As an example, the weight 115 is provided on a back surface (inner surface) of the upper surface wall of the housing 111. Therefore, as an example, the weight 115 is positioned over the vibrator 112. In this case, the vertical direction (Z-direction) is an example of the second direction crossing the vibration direction of the vibrator 112 (X-direction and is an example of the first direction). The back surface of the upper side wall of the housing 111 where the weight 115 is provided is an example of the part of the housing 111 located on a second direction side.

It should be noted that the second direction is not limited to the vertical direction (Z-direction) but may be the transverse direction (Y-direction) of the vibrator 112. The weight 115 may be provided on the lower side wall or on the back surface (inner surface) of the side wall of the housing 111. The weight 115 may be provided on the upper side wall, the lower side wall, or the outer surface of the side wall of the housing 111. In this manner, the weight 115 is provided on one surface of the wall of the housing 111.

With the weight 115 fixed to the housing 111, the center of gravity CG of the actuator 110 is displaced from the center of the actuator 110 and is displaced from the center of gravity of the vibrator 112. The deviation of the center of gravity CG of the actuator 110 from the center of the actuator 110 means that the center of gravity CG of the actuator 110 is eccentric.

The weight 115 is provided such that, by eccentricizing the center of gravity CG of the actuator 110, the entire actuator 110 vibrates with rotation like a cradle when the vibrator 112 vibrates in the X-direction. The center of gravity CG is the center of gravity of the entire actuator 110 when the vibrator 112 is stopped.

Since the actuator 110 is provided inside the cushion member 11E, when the vibrator 112 starts to vibrate in the X-direction, the cushion member 11E around the actuator 110 deforms. Therefore, the center of gravity CG of the actuator 110 is at the position as illustrated in FIG. 4A when the vibrator 112 is stopped, but when the vibrator 112 starts to vibrate, the center of gravity CG of the actuator 110 is shifted off from the position shown in FIG. 4A. Even when the vibrator 112 is vibrating, the center of gravity CG of the actuator 110 is eccentric.

When the vibrator 112 starts to vibrate from the state where the vibrator 112 is stopped, the axis passing through the center of gravity CG in the Y-direction at the position as illustrated in FIG. 4A becomes the axis where the rotational moment is generated and the actuator 110 starts to vibrate. Then, while the center of gravity CG is displaced from the position shown in FIG. 4A, the actuator 110 repeatedly vibrates while including the rotational moment in a state where the center of gravity CG is eccentric. In FIG. 4A, the direction of the vibration while including the rotational moment is indicated by a bidirectional arrow.

Such vibration includes a Z-directional component. That is, even when the cushion member 11E is limited in thickness in the Z-direction and the vibrator 112 cannot vibrate in the Z-direction, the actuator 110 can generate vibration including the component in the Z-direction perpendicular to the surface 11B1 of the seat portion 11B. The actuator 110 generally swings and vibrates in the X-direction while also vibrating in the Z-direction.

Although the center of gravity CG of the actuator 110 can also be made eccentric by shifting the center of gravity of the vibrator 112 off from the center of the housing 111, the center of gravity CG of the actuator 110 can be further shifted from the center of the actuator 110 by attaching the weight 115 to the housing 111. That is, by using the weight 115, the rotational moment can be greatly increased, and a sufficient vibration intensity can be obtained to present vibration to the user sitting on the seat portion 11B. Thus, by attaching the weight 115 to the housing 111, the rotational moment can be generated at a level usable as the tactile presentation device 100.

In addition, the heavier the weight 115, the greater the degree of eccentricity with respect to the center of gravity CG of the actuator 110 when it is stopped, and the greater the Z-directional component of vibration. Therefore, it is preferable that the weight 115 is heavier than the vibrator 112, that is, the heavier the weight 115 is, the greater the Z-directional component of vibration becomes.

Furthermore, as an example, the weight 115 is provided on one surface of the wall of the housing 111 located toward the thickness direction (Z-direction) of the cushion member 11E (flexible portion). The Z-directional component of eccentricity with respect to the center of gravity CG of the actuator 110 can be increased. As a result, the Z-directional component of the vibration of the actuator 110 increases, and tactile sensation can be presented with greater vibration.

In addition, when vibration is stopped, the center of gravity CG1 of the weight 115 may be shifted in the horizontal direction, so as to be away from the end of the seat portion 11B including the cushion member 11E, from the center of gravity CG of the vibrator 112. With such a configuration, the vibration of the Z-directional component is biased toward the center side of the seat portion 11B in a plan view, and the propagation of the vibration to the center side of the seat portion 11B in a plan view increases, and the vibration is readily transmitted to an occupant.

Although the weight 115 as illustrated in FIG. 4A is a separate body from the housing 111, the weight 115 may be a part of the housing 111 and formed by folding a part of the wall of the housing 111. For example, when the housing 111 is formed by folding a sheet metal, the upper wall of the housing 111 may be lengthened and folded to form the weight 115 as illustrated in FIG. 4A. The weight 115 can be readily formed by folding.

The above-described part of the housing 111 may include a material having a heavier specific gravity than other parts of the housing 111. The weight 115 can be readily formed by the material having a heavier specific gravity, and the weight 115 can be formed thinner.

### <Torque for Rotating Actuator 110>

FIG. 4B is a diagram for explaining torque for rotating the actuator 110. Here, torque T applied to the center of gravity CG of the actuator 110 when the vibration of the vibrator 112 is stopped will be described. FIG. 4B shows the center of gravity CG1 of the weight 115 and the center of gravity CG2 of the vibrator 112.

Let the mass of the weight 115 be m₁ and the mass of the vibrator 112 be m₂. Let l₁ be the distance between the center of gravity CG of the actuator 110 and the center of gravity CG1 of the weight 115 and l₂ be the distance between the center of gravity CG of the actuator 110 and the center of gravity CG₂ of the vibrator 112. Let F be the force generated in the center of gravity CG2 when the vibrator 112 vibrates. FIG. 4B shows, as an example, a state in which the vibrator 112 vibrates in the +X-direction.

The torque T for rotating the actuator 110 is T=F×l₂. That is, the longer the distance l₂ between the center of gravity CG of the actuator 110 and the center of gravity CG2 of the vibrator 112 is, the greater the torque T becomes.

Also, m₁×l₁=m₂×l₂ is established. The position of the center of gravity CG of the actuator 110 is a position where the distance 1 between the vibrator 112 and the weight 115 is distributed by the mass m₁ of the weight 115 and the mass m₂ of the vibrator 112. In order to increase the torque T, it is necessary to increase the distance l₂, and for this purpose, the mass m₁ of the weight 115 is increased.

### <Modified Example of Weight 115>

FIG. 4C is a diagram illustrating a configurational example of the actuator 110M according to a modified example of the embodiment. In the actuator 110M illustrated in FIG. 4C, the weight 115 is provided on the outer surface of the upper wall of the housing 111.

In the actuator 110M, the length of the weight 115 in the X-direction is, as an example, longer than the length of the housing 111 in the X-direction. Since the weight 115 is longer than the housing 111 in the X-direction in which the vibrator 112 vibrates, the degree of eccentricity of the center of gravity CG of the actuator 110M when the vibration is stopped increases, and thus the Z-directional component of the vibration becomes greater. By providing the weight 115 outside the housing 111, the length of the weight 115 in the X-direction can be made longer than the length of the housing 111 in the X-direction.

Moreover, in a plan view, the area of the weight 115 is larger than the area of the housing 111, as an example. By making the area of the weight 115 larger than the area of the housing 111, when the vibrator 112 vibrates, the area in which the vibration propagates to the cushion member 11E increases, and the vibration propagated to the surface 11B1 of the seat portion 11B becomes stronger. By providing the weight 115 outside the housing 111, the area of the weight 115 in a plan view can be made larger than the area of the housing 111 in a plan view.

In a plan view, the area of the weight 115 is larger than the area of the housing 111, as an example, and the weight 115 is provided to include the housing 111 in a plan view. When the weight 115 includes the housing 111 in a plan view, the outer edge of the weight 115 is positioned outside the outer edge of the housing 111 in a plan view. When the weight 115 includes the housing 111 in a plan view, the balance of the actuator 110 in a plan view is enhanced, such that the Z-directional component of the eccentricity of the center of gravity CG of the actuator 110M can be increased. Therefore, by making the area of the weight 115 larger than the area of the housing 111 and increasing the Z-directional component at the eccentricity of the center of gravity CG of the actuator 110M, when the vibrator 112 vibrates, the area where the vibration propagates to the cushion member 11E increases, and the Z-directional component of the vibration propagated to the surface 11B1 of the seat portion 11B increases.

In addition, the weight 115 may be provided on the housing 111 via a support. The support is a member which is positioned between the housing 111 and the weight 115 and fixes the weight 115 to the housing 111 while the weight 115 is separated from the housing 111. As such a support, for example, a spacer can be used. For example, in the actuator 110M as illustrated in FIG. 4C, the distance between the weight 115 and the vibrator 112 can be increased by sandwiching a spacer between the housing 111 and the weight 115. As a result, even when the weight of the weight 115 and the weight of the vibrator 112 are the same, the center point of generation of the rotational moment can be shifted in the direction away from the vibrator 112, such that a large cradle vibration can be generated.

### <Simulation Result>

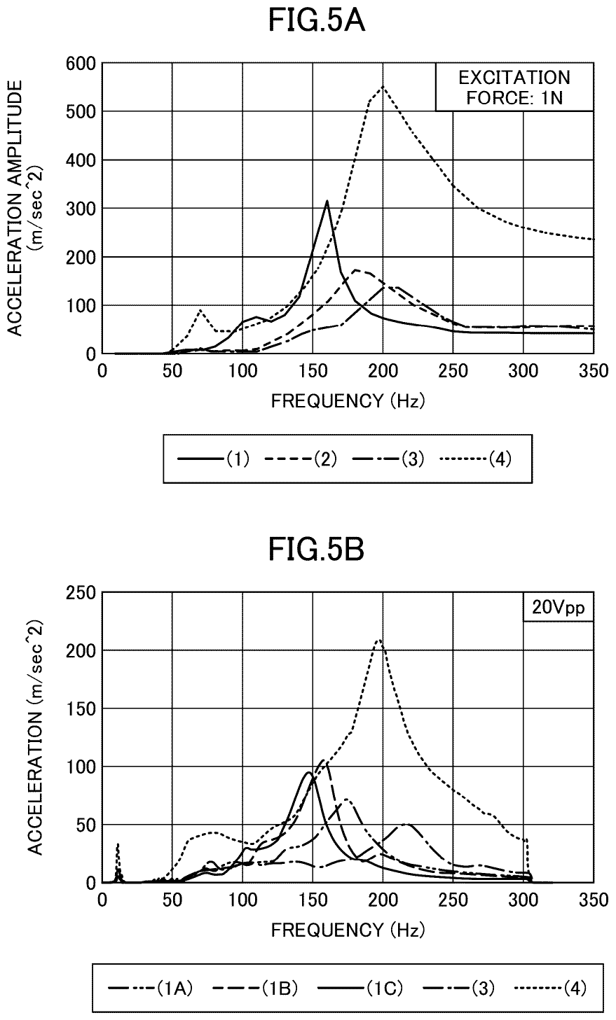

FIG. 5A is a graph illustrating an example of simulation results. Acceleration of vibration of the actuator 110 obtained by changing vibration frequency of the vibrator 112 was calculated by simulation.

Here, frequency characteristics with respect to acceleration of vibration of the actuator 110 were calculated for (1) the actuator 110 in which the weight 115 was an iron plate and (2) the actuator 110 in which the weight 115 was an ABS resin plate. Frequency characteristics with respect to acceleration of vibration were calculated for (3) an actuator for comparison without the weight 115 and (4) an actuator for comparison without the weight 115 and in which the vibrator vibrates in the Z-direction.

Although the actuator for comparison used in (4) did not include the weight 115, since the vibrator vibrated in the Z-direction, the acceleration of vibration rose from 50 Hz and peaked at 200 Hz. A peak value of acceleration was about twice that of (1), which was the highest among (1) to (3).

Since the actuator for comparison used in (3) had a configuration in which the weight 115 was omitted from the actuator 110, the center of gravity of the actuator roughly coincides with the center of gravity of the vibrator 112. Since rotational moment was not appreciably obtained, the acceleration of vibration was the smallest.

Since the weight 115 of the actuator 110 of (1) was a heavy iron plate, acceleration of vibration equivalent to that of the actuator for comparison used in (4) (vibrator vibrates in the Z-direction) was obtained within a range from about 100 Hz to about 170 Hz.

Since the weight 115 of the actuator 110 of (2) was light as it was made of ABS resin, acceleration of vibration was smaller than that of the actuator 110 for comparison used in (1), but at about 170 Hz, acceleration of vibration that is approximately 2 times that of the actuator for comparison used in (3) was obtained.

From the above simulation results, it was found that the weight 115 is preferably heavier, and there is a frequency band in which acceleration of vibration equivalent to that of the actuator for comparison used in (1) (vibrator vibrates in the Z-direction) can be obtained.

### <Actual Measurement Results>

FIG. 5B is a graph illustrating an example of the actual measurement results. The acceleration of the actuator 110 obtained when the vibration frequency of the vibrator 112 was changed was measured.

In this study, the frequency characteristics with respect to acceleration of vibration of the actuator 110 were measured for (1A) the actuator 110 in which one iron plate was used as the weight 115, (1B) the actuator 110 in which two iron plates were used as the weight 115, and (1C) the actuator 110 in which three iron plates were used as the weight 115. The frequency characteristics with respect to acceleration of vibration were also measured for (3) an actuator for comparison without the weight 115, and (4) an actuator for comparison without the weight 115 and in which the vibrator vibrates in the Z-direction. A 3-axes acceleration sensor was used to measure the acceleration of vibration.

Although the actuator for comparison used in (4) did not include the weight 115, large acceleration of vibration was obtained because the vibrator vibrated in the Z-direction. The acceleration of vibration rose from 50 Hz and peaked at about 200 Hz. The peak value of the acceleration was about twice the value of (1B), which was the largest among (1A) to (1C) and (3).

Since the actuator for comparison used in (3) had the configuration omitting the weight 115 from the actuator 110, the center of gravity of the actuator roughly coincides with the center of gravity of the vibrator 112. Since little rotational moment was obtained, the acceleration of vibration was the smallest.

The actuator 110 of (1A) includes an iron plate as the weight 115. At about 120 Hz to about 180 Hz, the acceleration of vibration greater than that of the actuator for comparison (without the weight 115) used in (3) was obtained. The peak value at about 175 Hz was about 1.5 times the peak value at about 220 Hz of (3).

The actuator 110 of (1B) includes two iron plates as the weight 115, and thus the iron plates weigh twice the weight of the weight 115 of (1A). At about 120 Hz to about 160 Hz, the acceleration of vibration was about twice the size of that of the actuator 110 of (1A) and the acceleration of vibration equivalent to that of the actuator for comparison (Z-directional vibration) used in (4) was obtained. The peak value of the acceleration of vibration at about 160 Hz was greater than that of the actuator 110 of (1C) at about 140 Hz.

The actuator 110 of (1C) includes three iron plates as the weight 115, and thus the iron plates weigh 3 times the weight of the weight 115 of (1a). At about 100 Hz to about 140 Hz, the acceleration of vibration equivalent to that of the actuator for comparison (Z-directional vibration) used in (4) was obtained.

From the above measured results, it was confirmed that the weight 115 was preferably heavier, and that there was a frequency band in which the acceleration of vibration equivalent to that of the actuator for comparison (Z-directional vibration of the vibrator) used in (1) can be obtained. These measurement results showed the same tendency as the simulation results as illustrated in FIG. 5A.

### <Simulation Results of Sound Pressure Distribution>

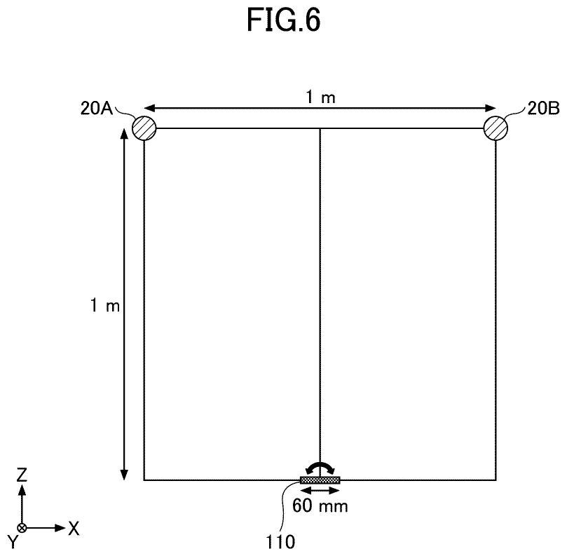

FIG. 6 is a diagram illustrating an example of a simulation model used to obtain simulation results of sound pressure distribution. In FIG. 6, the position of the actuator 110 and, with shaded circles, the positions of two microphones 20A and 20B whose sound pressures were measured are indicated. The actuator 110 was positioned at 0 m in the Z-direction, and the length in the X-direction was 60 mm as an example.

The microphone 20A was located 0.5 m in the −X-direction and 1 m in the +Z-direction from the actuator 110. The microphone 20B was located 0.5 m in the +X-direction and 1 m in the +Z-direction from the actuator 110.

As illustrated in FIG. 6, the space in which the simulation was performed was 1 m in the +Z-direction from the actuator 110 and 1 m in the X-direction between the microphones 20A and 20B. In the simulation, the sound speed was set to 343.24 m/second, which is the sound speed at 1 atm at 20° C.

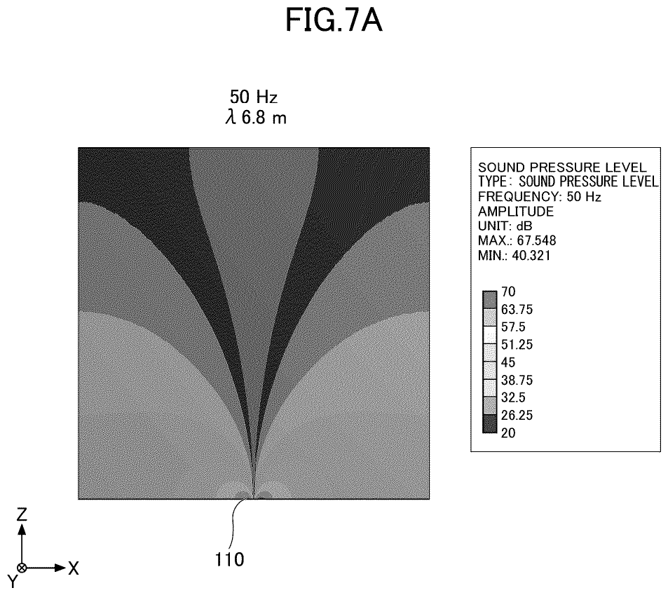

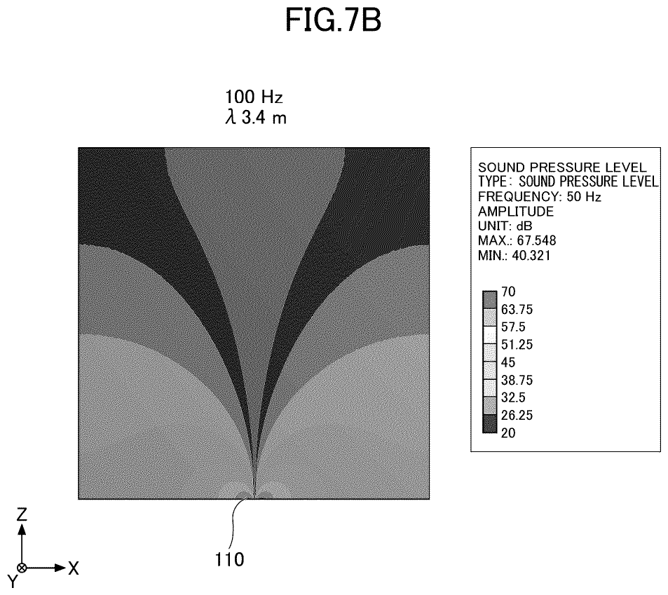

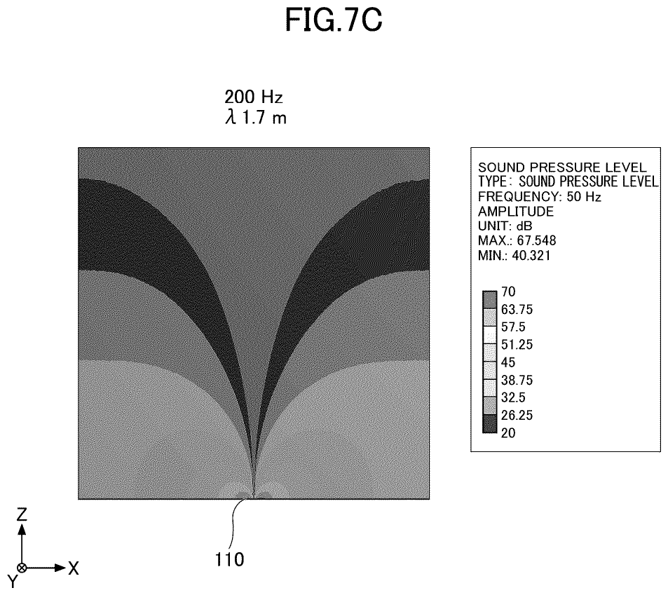

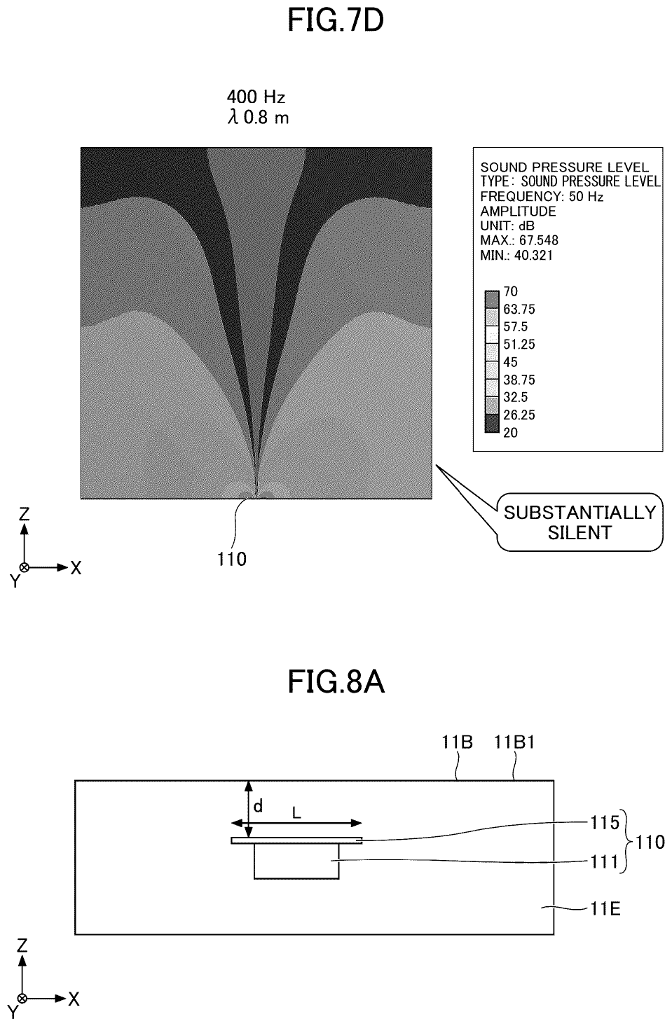

In this simulation model, the frequencies of the driving signals for driving the actuator 110 were set to 50 Hz, 100 Hz, 200 Hz, and 400 Hz, and the sound pressure distribution of the sound generated from the seat portion 11B (see FIG. 3) of the seat 11 was calculated. As a result, sound pressure distributions as illustrated in FIGS. 7A to 7D were obtained. In FIG. 6, the seat portion 11B of the seat 11 is omitted.

FIGS. 7A to 7D are diagrams illustrating examples of the simulation results. FIGS. 7A to 7D show the sound pressure distributions of the sound generated from the seat portion 11B of the seat 11 when the actuator 110 is driven. In FIGS. 7A to 7D, the range of the sound pressure from low to high is shown in gradation from white to black. The sound pressure distributions as illustrated in FIGS. 7A to 7D are the distributions at the timing when the amplitude of the sound pressure is maximized.

As illustrated in FIG. 7A, in the case of the 50 Hz drive signal (wavelength λ=about 6.8 m), a sound pressure level within an area of about 0.5 m from the actuator 110 was substantially silence, that is, inaudible to a human being, and the sound pressure decreased even further at a farther distance.

The same tendency was also confirmed in the case of the 100 Hz drive signal (wavelength λ=about 3.4 m) as illustrated in FIG. 7B, the case of the 200 Hz drive signal (wavelength λ=about 1.7 m) as illustrated in FIG. 7C, and the case of the 400 Hz drive signal (wavelength λ=about 0.8 m) as illustrated in FIG. 7D.

The reason why the sound was at a level of substantially silence around the actuator 110 is that the vibrator 112 vibrates in the X-direction inside the actuator 110, and phases of the vibration generated on the +X-direction side and the vibration generated on the −X-direction side of the vibrator 112 are opposite to each other, which causes cancellation of the sound.

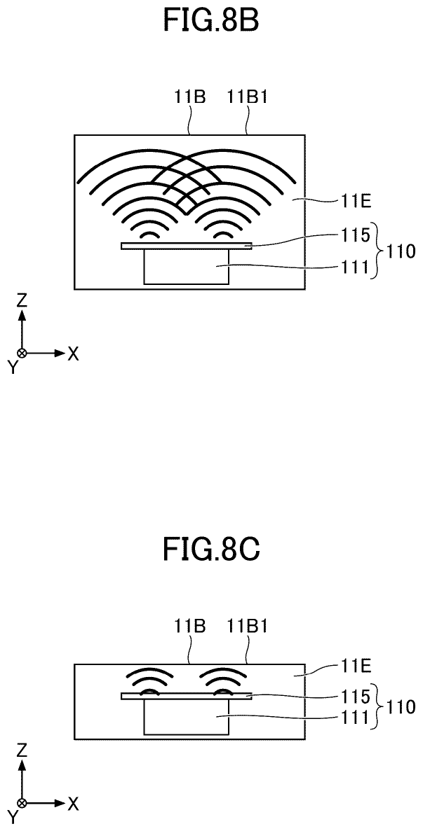

From the results of FIGS. 7A to 7D, it was confirmed that even when the actuator 110 is provided inside the seat portion 11B, a sound at a level that can be heard by a human being is not generated, and thus the sound is substantially silent.

<Relationship Between Length L of Weight 115 in X-Direction and Depth d>
FIG. 8A is a diagram illustrating a length L of the weight 115 of the actuator 110 in the X-direction and a depth d from the surface 11B1 of the seat portion 11B. FIG. 8B is a diagram schematically illustrating an example of the Z-directional component of vibration when the depth d is deep. FIG. 8C is a diagram schematically illustrating an example of the Z-directional component of vibration when the depth d is shallow.

The Z-directional component of vibration generated at the end of the weight 115 in the +X-direction and the Z-directional component of vibration generated at the end of the weight 115 in the −X-direction are considered to be in opposite phases since the vibrator 112 is vibrating in the X-direction.

When the depth d is deep, as illustrated in FIG. 8B, the Z-directional components of the vibration generated at the end of the weight 115 in the +X-direction and at the end of the −X-direction are synthesized inside the cushion member 11E, cancel each other, and attenuate.

Furthermore, when the depth d is shallow, as illustrated in FIG. 8C, it is considered that components in the Z-direction of vibration generated at the end portion in the +X-direction and the end portion in the −X-direction of the weight 115 are not synthesized inside the cushion member 11E and reach the surface 11B1 of the seat portion 11B.

When d<L/2 is established, it is considered that the Z-directional components of vibration generated at the end portion in the +X-direction and the end portion in the −X-direction of the weight 115 are not synthesized inside the cushion member 11E and cancellation of vibration can be suppressed. Therefore, it is preferable to provide the actuator 110 inside the cushion member 11E such that d<L/2 is established for the length L of the weight 115 of the actuator 110 in the X-direction and the depth d from the surface 11B1 of the seat portion 11B.

### Advantageous Effect

A vibration generator (actuator 110) includes the housing 111; the vibrator 112 housed in the housing 111 and including a permanent magnet or an electromagnetic coil; the spring (elastic support) 113 configured to elastically support the vibrator 112; the drive part provided in the housing 111 and including the electromagnetic coil 114 capable of generating a force for magnetically attracting the vibrator 112 including the permanent magnet in the first direction, or the permanent magnet capable of generating the force for magnetically attracting the vibrator 112 including the electromagnetic coil in the first direction; and the weight 115 provided in a part of the housing 111 on the side of the direction crossing the first direction. The rotational moment can be generated by a simple configuration in which the weight 115 is provided in a part of the housing 111 on the side of the direction crossing the first direction, and cradle vibration (arcuate vibration) which vibrates in two directions, namely, an up-down (vertical) direction and a left-right (horizontal) direction, can be generated.

Therefore, it is possible to provide a vibration generator in which the vibrator vibrates in the direction along the surface on which vibration is to be generated and that is capable of generating vibration in the direction perpendicular to the surface on which vibration is to be generated.

The weight 115 may be heavier than the vibrator 112. The degree of eccentricity of the center of gravity CG of the actuator 110 increases, and the Z-directional component of vibration can be increased.

The weight 115 may be provided on one surface of the wall of the housing 111. By providing the weight 115 on one surface of the housing 111 away from the vibrator 112, the weight 115 can be readily fixed away from the vibrator 112.

The weight 115 may be provided on the housing 111 via a support. By increasing the distance between the weight 115 and the vibrator 112, the degree of eccentricity with respect to the center of gravity of the actuator 110 increases, and the Z-directional component of the vibration can be increased by the greater rotational moment. In addition, even when the weight of the weight 115 and the weight of the vibrator 112 are the same, the Z-directional component of the vibration can be increased by the greater rotational moment.

In addition, the housing 111 may include a metallic material and the weight 115 may be a part of the housing 111. Since the weight 115 and the housing 111 can be integrated, it is not necessary to provide the weight 115 separately from the housing 111, and a simple configuration can be achieved.

In addition, the weight 115 may be formed by folding a part of the housing 111. The weight 115 can be readily formed by folding a sheet metal or the like.

A part of the housing 111 may include a material having a heavier specific gravity than other parts of the housing 111. The weight 115 can be readily formed by being formed with the material having a heavier specific gravity.

The tactile presentation device 100 includes: the housing 111; the vibrator 112 housed in the housing 111 and including a permanent magnet or an electromagnetic coil; the spring (elastic support) 113 configured to elastically support the vibrator 112; the drive part provided in the housing 111 and including the electromagnetic coil 114 capable of generating a force for magnetically attracting the vibrator 112 including the permanent magnet in the first direction, or the permanent magnet capable of generating the force for magnetically attracting the vibrator 112 including the electromagnetic coil in the first direction; the weight 115 provided in a part of the housing 111 on the side of the direction crossing the first direction; and the control circuitry 121 configured to control drive of the electromagnetic coil. The rotational moment can be generated by a simple configuration in which the weight 115 is provided in a part of the housing 111 on the side of the direction crossing the first direction, and cradle vibration (arcuate vibration) vibrating in two directions, namely, an up-down (vertical) direction and a left-right (horizontal) direction, can be generated.

Therefore, it is possible to provide a tactile presentation device in which the vibrator vibrates in the direction along the surface on which vibration is to be generated and that is capable of generating vibration in the direction perpendicular to the surface on which vibration is to be generated.

The seat system 200 including the seat 11 provided with the seat portion 11B and the backrest portion 11A, and the tactile presentation device 100, wherein the tactile presentation device 100 includes the housing 111 provided in the cushion member 11E (flexible portion) of the seat portion 11B or the backrest portion 11A of the seat 11; the vibrator 112 housed in the housing 111 and including a permanent magnet or an electromagnetic coil; the spring (elastic support) 113 configured to elastically support the vibrator 112; the drive part provided in the housing 111 and including the electromagnetic coil 114 capable of generating a force for magnetically attracting the vibrator 112 including the permanent magnet in the first direction, or the permanent magnet capable of generating the force for magnetically attracting the vibrator 112 including the electromagnetic coil in the first direction; the weight 115 provided in a part of the housing 111 on the side of the direction crossing the first direction; and the control circuitry 121 configured to control drive of the electromagnetic coil. The rotational moment can be generated by a simple configuration in which the weight 115 is provided in a part of the housing 111 on the side of the direction crossing the first direction, and cradle vibration (arcuate vibration) vibrating in two directions, namely, an up-down (vertical) direction and a left-right (horizontal) direction, can be generated.

Therefore, it is possible to provide a seat system in which the vibrator vibrates in the direction along the surface on which vibration is to be generated and that is capable of generating vibration in the direction perpendicular to the surface on which vibration is to be generated.

In addition, when vibration is stopped, the center of gravity of the weight 115 may be shifted in the horizontal direction, so as to be away from the end of the seat portion 11B or the backrest portion 11A including the cushion member 11E (flexible portion), from the center of gravity of the vibrator 112. The vibration of the Z-directional component is biased toward the center side of the seat portion 11B in a plan view, and the propagation of the vibration to the center side of the seat portion 11B in a plan view increases, and the vibration is readily transmitted to an occupant.

In a plan view, the area of the weight 115 may be larger than the area of the housing 111. By making the area of the weight 115 larger than the area of the housing 111, when the vibrator 112 vibrates, the area where the vibration propagates to the cushion member 11E increases, and the vibration propagated to the surface 11B1 of the seat portion 11B becomes stronger.

The weight 115 may be provided on one surface of the wall of the housing 111 located toward the thickness direction of the cushion member 11E (flexible portion). The Z-directional component of the eccentricity of the center of gravity CG of the actuator 110 can be increased. As a result, the Z-directional component of the vibration of the actuator 110 increases, and tactile sensation can be presented with greater vibration.

Provided are the vibration generator, the tactile presentation device, and the seat system, in which a vibrator vibrates in a direction along a surface on which vibration is to be generated and can generate vibration in a direction perpendicular to the surface on which vibration is to be generated.

Although the vibration generator, tactile presentation device, and seat system of the exemplary embodiments of the present disclosure have been described above, the present disclosure is not limited to the specifically disclosed embodiments and can be modified and changed in various ways without departing from the scope of the claims.

What is claimed is:

1. A vibration generator attached to a target that is used in a state while being in contact with at least a part of a body of a user, and transmitting vibration to the part of the body of the user by vibrating the target, the vibration generator comprising:
a housing;
a vibrator housed in the housing and including a permanent magnet or an electromagnetic coil;
an elastic support housed in the housing and configured to elastically support the vibrator;
a drive part housed and provided in the housing and including the electromagnetic coil capable of generating a force for magnetically attracting the vibrator including the permanent magnet in a first direction, or the permanent magnet capable of generating the force for magnetically attracting the vibrator including the electromagnetic coil in the first direction; and
a weight provided in a part of the housing located toward a second direction crossing the first direction.

2. The vibration generator according to claim 1, wherein
the weight is heavier than the vibrator.

3. The vibration generator according to claim 1, wherein
the weight is provided on one surface of a wall of the housing.

4. The vibration generator according to claim 1, wherein
the weight is provided on the housing via a support.

5. The vibration generator according to claim 1, wherein
the housing includes a metallic material and the weight is the part of the housing.

6. The vibration generator according to claim 5, wherein
the weight is formed by folding the part of the housing.

7. The vibration generator according to claim 5, wherein
the part of the housing includes a material having a heavier specific gravity than other parts of the housing.

8. A tactile presentation device provided with a vibration generator attached to a target that is used in a state while being in contact with at least a part of a body of a user, and transmitting vibration to the part of the body of the user by vibrating the target, the tactile presentation device comprising:
the vibration generator; and
control circuitry, wherein
the vibration generator includes a housing;
a vibrator housed in the housing and including a permanent magnet or an electromagnetic coil;
an elastic support housed in the housing and configured to elastically support the vibrator;
a drive part housed and provided in the housing and including the electromagnetic coil capable of generating a force for magnetically attracting the vibrator including the permanent magnet in a first direction, or the permanent magnet capable of generating the force for magnetically attracting the vibrator including the electromagnetic coil in the first direction; and
a weight provided in a part of the housing located toward a second direction crossing the first direction; and
the control circuitry is configured to control drive of the electromagnetic coil.

9. A seat system comprising:
a seat including a seat portion and a backrest portion; and
a tactile presentation device, wherein
the tactile presentation device includes
a vibration generator; and
control circuitry, wherein
the vibration generator includes
a housing provided in a cushion member of the seat portion or the backrest portion of the seat;
a vibrator housed in the housing and including a permanent magnet or an electromagnetic coil;
an elastic support housed in the housing and configured to elastically support the vibrator;
a drive part housed and provided in the housing and including the electromagnetic coil capable of generating a force for magnetically attracting the vibrator including the permanent magnet in a first direction, or the permanent magnet capable of generating the force for magnetically attracting the vibrator including the electromagnetic coil in the first direction; and
a weight provided in a part of the housing located toward a second direction crossing the first direction, and
the control circuitry is configured to control drive of the electromagnetic coil,
the housing is embedded in the cushion member and is configured to deform in both upper and lower portions of the housing in a thickness direction of the cushion member upon a seat user sitting on the cushion member,
the housing is disposed in the cushion member such that the first direction is parallel to a surface of the seat portion or the backrest portion,
the vibration generator is formed such that a center of gravity of the vibration generator and the center of gravity of the vibrator are at different locations, and
the vibration generator provides vibration that vibrates in a direction orthogonal to the surface of the seat portion or the backrest portion, along the surface of the seat portion or the backrest portion, by generating the vibration including a rotational moment by vibrating the vibrator in the first direction.

10. The seat system according to claim 9, wherein
when the vibration is stopped, the center of gravity of the weight is shifted in a horizontal direction, so as to be away from an end of the seat portion or the backrest portion including the cushion member, from the center of gravity of the vibrator.

11. The seat system according to claim 9, wherein
in a plan view, an area of the weight is larger than an area of the housing.

12. The seat system according to claim 9, wherein
the weight is provided on one surface of a wall of the housing located toward the thickness direction of the cushion member.
